(19) United States
(12) Patent Application Publication
(10) Pub. No.: US 2019/0035338 A1
(43) Pub. Date: Jan. 31, 2019

(54) DISPLAY DEVICE AND METHOD FOR DRIVING THE SAME

(71) Applicant: BOE TECHNOLOGY GROUP CO., LTD., Beijing (CN)

(72) Inventor: Zhihong DU, Beijing (CN)

(21) Appl. No.: 15/752,672

(22) PCT Filed: Aug. 29, 2017
(86) PCT No.: PCT/CN2017/099480

§ 371 Date: Feb. 14, 2018

(30) Foreign Application Priority Data
Sep. 29, 2016 (CN) 201610866770.3

(51) Int. Cl. G09G 3/34; G02F 1/1362; G09G 3/36; F21V 8/00; G02F 1/1368; G02F 1/137

(52) U.S. Cl. CPC G09G 3/342; G02F 1/136209; G09G 3/3648; G02F 2001/133342; G02F 1/1368; G02F 1/137; G02B 6/0041

(57) ABSTRACT

The present application provides a display device and a method for driving the same. The display device includes: a transparent display panel including two display surfaces; a controller; and display switching components and backlights provided at the two display surfaces of the display panel, respectively. The controller is configured to control the display switching components to turn on or turn off, such that the display device is in the transparent state when each of the display switching components is turned off and in the opaque state when one of the display switching components is turned on.

### CROSS-REFERENCE TO RELATED APPLICATIONS

This is a National Phase Application filed under 35 U.S.C. 371 as a national stage of PCT/CN2017/099480, filed on Aug. 29, 2017, an application claiming the benefit of Chinese Application No. 201610866770.3, filed on Sep. 29, 2016, the content of each of which is hereby incorporated by reference in its entirety.

### TECHNICAL FIELD

The present disclosure relates to the field of display technology, and particularly, to a display device and a method for driving the same.

### BACKGROUND

As a human-computer interface product, display panels have been widely used in production and life. Most display panels in the related art have only one-side display function, that is, only one side of the display panel can display images. However, in facilities such as a digital signage, an electronic communication device, a cashier facility, an inquiry window, an exhibition hall and the like, it is often necessary for the display panel to have a capability of displaying images on both sides, which means the display panel needs to have two display surfaces that can display images.

### SUMMARY

The present disclosure provides a display device, including:

a transparent display panel including two display surfaces each capable of displaying an image;

display switching components provided at the two display surfaces of the display panel, respectively, and configured to switch a state of the display device between a transparent state and an opaque state; and

a controller configured to control the display switching components to turn on or turn off, such that the display device is in the transparent state when each of the display switching components is turned off and in the opaque state when one of the display switching components is turned on.

Optionally, the display switching components are provided parallel to the display surfaces of the display panel, respectively.

Optionally, each of the display switching components includes a light guide plate provided with light scattering particles and a first light source provided on at least one side of the light guide plate, the first light source being an edge-type light source; and the controller is configured to control the first light sources to turn on or turn off, such that the display device is in the transparent state when each of the first light sources is turned off and in the opaque state when one of the first light sources is turned on.

Optionally, each of the display switching components includes a retractable curtain, and

the controller is configured to control the curtains to retract or unfold, such that the display device is in the transparent state when each of the curtains is retracted and in the opaque state when one of the curtains is unfolded.

Optionally, each of the display switching components further includes a second light source provided between the curtain and the display panel.

Optionally, shafts are provided close to one side edge of the display panel, one end of each of the curtains is fixed onto one of the shafts, and each of the shaft is capable of rotating to retract or unfold the curtain.

Optionally, each of the curtains is made of a flexible and reflective material.

Optionally, in each of the display switching components, a light emitting direction of the second light sources is a direction towards the curtain.

Optionally, the controller is configured to control the display switching component at one of the display surfaces to turn on and the display switching component at the other of the display surfaces to turn off, such that the display device is in the opaque state.

Optionally, the display device further includes backlights provided at the two display surfaces of the display panel, respectively, and configured to provide backlight to the display panel,

wherein in a case where the display device is in the transparent state, the controller is configured to control the backlight at one of the two display surfaces to turn on, such that the display panel displays an image on one of the two display surfaces in a transparent state.

Optionally, a light emitting direction of each of the backlights is a direction towards the display panel.

Optionally, the display panel is a double-sided liquid crystal display panel including an array substrate, and a thin film transistor is disposed on a substrate of the array substrate.

Optionally, the thin film transistor includes a metal component, and a light shielding layer is provided between the metal component and the substrate.

Optionally, the metal component includes at least one of a gate electrode, a source/drain electrode, a gate line and a data line.

Optionally, the display device further includes a driving circuit connected with the display panel, and the controller is configured to control the driving circuit to input a driving signal to the display panel to drive the display panel to display.

Optionally, the driving circuit is configured to provide a normal driving signal when an image is displayed on one of the display surfaces and provide an inverted driving signal when the image is displayed on the other display surface opposite to the one of the display surfaces, the inverted driving signal being generated by inverting the normal driving signal.

Optionally, the driving circuit is configured to identify a position of a viewer viewing the display device according to a signal from the controller, and provide one of the normal driving signal and the inverted driving signal according to the position of the viewer.

Optionally, the controller includes a manual switch or a remote sensor.

The present disclosure also provides a method for driving a display device. The display device is the aforementioned display device, and the method includes steps of:

transmitting, by the controller, a signal to the display panel, and determining, by the display panel, a position of a viewer viewing the display device relative to the display device according to a transmitting direction of the signal; and

controlling, by the controller, the display switching components to turn on or turn off according to the determined position of the viewer relative to the display device such that the display device is in the transparent state when each of the display switching components is turned off and in the opaque state when one of the display switching components is turned on, and controlling, by the controller, the backlights to turn on or turn off such that the display panel displays an image on one of the two display surfaces.

### BRIEF DESCRIPTION OF DRAWINGS

FIG. 1 is a schematic diagram illustrating a structure of a display device according to an embodiment of the present disclosure;

FIGS. 2 to 4 are schematic diagrams illustrating a display device including a light guide plate according to an embodiment of the present disclosure;

FIGS. 5 to 7 are schematic diagrams illustrating a display device including a curtain according to an embodiment of the present disclosure;

FIGS. 8 and 9 are schematic diagrams illustrating a structure of a display panel according to an embodiment of the present disclosure;

FIG. 10 is a schematic diagram illustrating a structure of a display device including a driving circuit according to an embodiment of the present disclosure; and

FIG. 11 is a schematic flow chart of a method for driving a display device according to an embodiment of the present disclosure.

### DETAILED DESCRIPTION

To make those skilled in the art better understand the technical solutions of the present disclosure, the present disclosure will be further described in detail below in conjunction with the accompanying drawings and specific implements.

It has been found that at least the following problem exists in the related art: the existing double-sided display device cannot switch between a transparent state and an opaque state to meet different viewing requirements.

The present disclosure provides, inter alia, a display device and a method for driving the same that substantially obviate one or more of the problems due to limitations and disadvantages of the related art.

The present disclosure provides a display device. As illustrated in FIG. 1, the display device includes a display panel 1, display switching components 2, backlights 3, and a controller (not illustrated in FIG. 1). The display panel 1 is transparent and includes two display surfaces opposite to each other. The display switching components 2 are provided at the two display surfaces of the display panel 1, respectively. The backlights 3 are provided at the two display surfaces of the display panel 1, respectively. The controller controls the display switching components 2 to turn on or turn off such that the display device is in a transparent state when each of the display switching components is turned off and in an opaque state when one of the display switching components is turned on, and controls the backlights 3 to turn on or turn off such that the display panel 1 displays an image on one of the two display surfaces.

The display panel 1 of the display device according to the present embodiment includes two display surfaces. When the controller controls the display switching component at one side to turn on, the display device is in single-sided opaque display. When the backlight at one side is controlled to turn on and the display switching components at both sides are controlled to turn off, the display device is in single-sided transparent display. As such, the display device according to an embodiment of the present disclosure can meet various viewing requirements.

In some embodiments, the display switching components 2 are provided parallel to the display surfaces of the display panel.

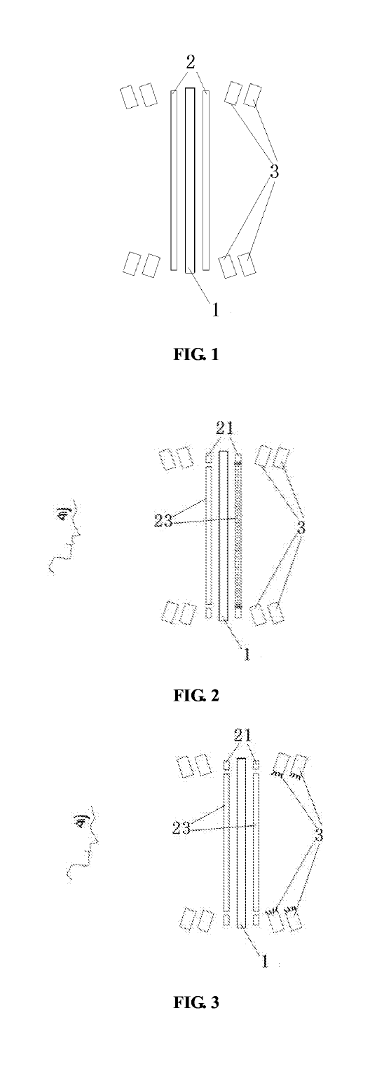

In some embodiments, as illustrated in FIGS. 2 to 4, each of the display switching components 2 may include a light guide plate 23 provided with light scattering particles, and a first light source 21 provided on at least one side of the light guide plate 23. The first light source 21 is an edge-type light source.

FIG. 2 illustrates a case where the display device is in opaque display when the viewer is on the left side of the display panel. In this case, the controller controls the first light source 21 on the right side of the display panel 1 to turn on (namely, the first light source is lit) and controls the first light source 21 on the left side to turn off. Light from the first light source 21 on the right side enters into the light guide plate 23 on said side from a side surface of the light guide plate 23, and the light guide plate 23 is in a diffusing state due to the scattering of light by the light scattering particles. At this time, the viewer can only see the diffusing-state light guide plate 23 on the right side through the display panel 1, and an object behind the light guide plate 23 on the right side is blocked. In other words, the display panel 1 is in single-sided opaque display.

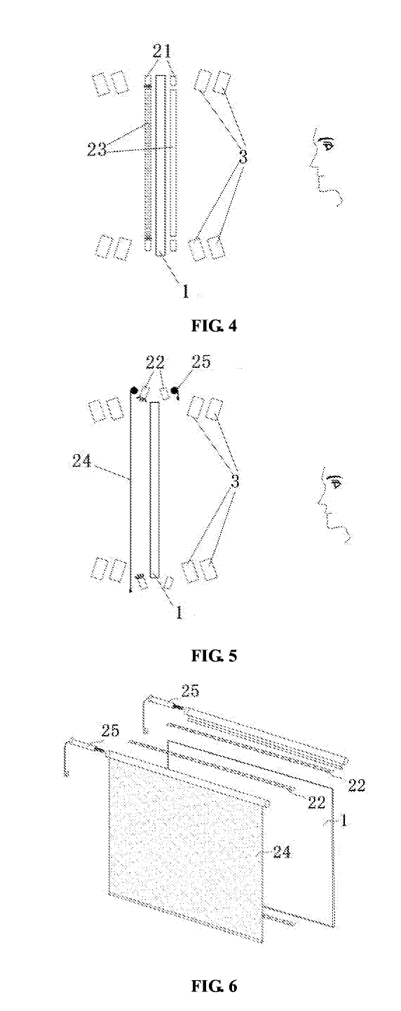

FIG. 3 illustrates a case where the display device is in transparent display when the viewer is on the left side of the display panel. In this case, the controller controls the first light source 21 on the right side of the display panel 1 to turn off and the backlight 3 on the right side to turn on. Light enters into the light guide plate 23 on the right side from a back surface of the light guide plate 23 and the light scattering particles do not scatter the light, and thus the light guide plate 23 is in a transparent state. At this time, the viewer can see an image displayed on the display surface on the left side of the display panel 1 and also see the object behind the light guide plate 23 through the display panel 1. In other words, the display panel 1 is in a single-sided transparent display state. It can be understood that the above example in which the viewer is on the left side is merely illustrative, and an example in which the viewer is on the right side as illustrated in FIG. 4 is similar to the example in which the viewer is on the left side, and the description thereof will not be repeated herein.

In some embodiments, as illustrated in FIGS. 5 to 7, each of the display switching component 2 may include a retractable curtain 24 and a second light source that is disposed between the curtain 24 and the display panel 1 and close to the top or bottom of the display panel (for example, at least one side edge at the top or bottom of the display panel).

Optionally, shafts 25 are provided close to one side edge of the display panel 1. One edge of each of the curtains 24 is fixed onto one of the shafts 24, and the shaft 24 can rotate to retract or unfold the curtain 24.

Optionally, each of the curtains 24 is made of a flexible and reflective material.

Optionally, in each of the display switching component 2, a light emitting direction of the second light source 22 is a direction towards the retractable curtain 24.

Optionally, a light emitting direction of each of the backlights 3 is a direction towards the display panel 1.

That is to say, the curtains 24 are disposed at both sides of the transparent display panel 1, respectively, and the second light sources 22 are disposed at both sides of the transparent display panel 1, respectively, as illustrated in FIGS. 5, 6, and 7. The curtains 24 are made of white, flexible and reflective material. FIGS. 5 and 6 illustrate a case where the display device is in opaque display when the viewer is on the right side of the display panel 1. In this case, the controller controls the second light source 22 on the left side of the display panel 1 to turn on (namely, the second light source is lit), the curtain 24 on the left side to unfold and the curtain 24 on the right side to retract, and the viewer can thereby see an image displayed on the display surface on the right side of the display panel 1 but cannot see the object behind the display panel 1 due to the blocking of the curtain 24. In other words, the display panel 1 is in a single-sided opaque display state. As illustrated in FIG. 7, when the backlight 3 (referring to FIG. 5) at one side is controlled to turn on and the display switching components 2 are controlled to turn off (namely, the curtains 24 at both sides are retracted and the second light sources 22 at both sides are turned off), the display panel 1 is in a single-sided transparent display state.

It should be noted that the curtain 24 and the second light source 22 on one side need not be turned on or off at the same time. For example, when the curtain 24 on the left side is unfolded, the second light source 22 on the left side may not be turned on. At this time, the display panel is in the opaque state. In this case, the backlight for display may be provided by another light source (for example, the backlight 3 on the right side).

Optionally, the display panel 1 is a double-sided liquid crystal display panel 1 including an array substrate 11, and a thin film transistor is disposed on a substrate 14 of the array substrate 11.

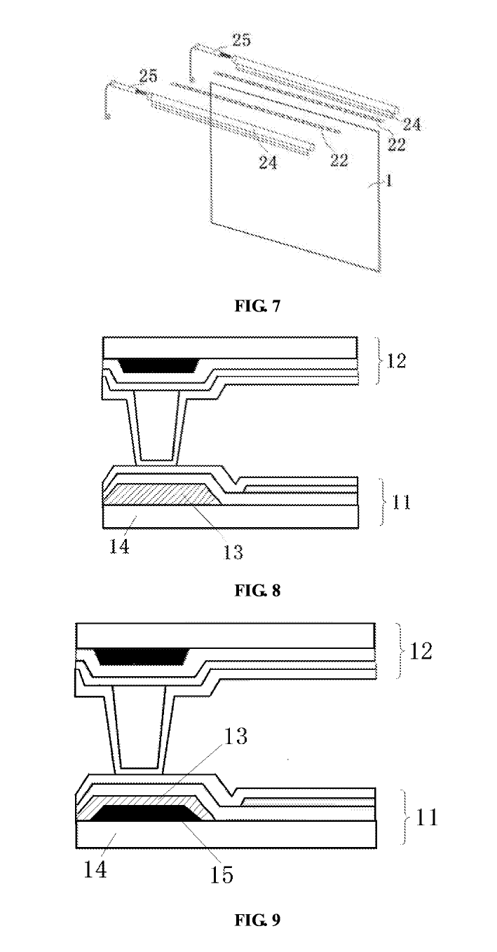

That is to say, the display panel 1 may be a liquid crystal display panel 1, a specific structure of which is illustrated in FIGS. 8 and 9. Specifically, the display panel 1 includes the array substrate 11 and a color filter substrate 12. The array substrate 11 and the color filter substrate 12 are both transparent, so the viewer can view a surface of the array substrate 11 away from the color filter substrate 12 at one side of the display panel, and also can view a surface of the color filter substrate 12 away from the array substrate 11 at the other side of the display panel. It can be understood that the liquid crystal display panel 1 may also be two transparent liquid crystal display panels 1 adhered together. That is, the array substrates 11 of the two transparent liquid crystal display panels 1 are adhered together, and the viewers at both sides view the color filter substrates 12 of the two display panels 1, respectively.

Optionally, the thin film transistor includes a metal component, and a light shielding layer 15 is provided between the metal component and the substrate 14.

That is, in a case where the display panel 1 is a liquid crystal display panel 1, when the viewer views a surface of the array substrate 11, display effect at the side of the array substrate 11 will be affected due to the fact that a gate electrode 13 of the array substrate 11 is usually made of metal and the metal layer will reflect light. To this end, the light shielding layer 15 is provided between the gate electrode 13 and the substrate 14 as illustrated in FIG. 9, thereby avoiding the reflection and enhancing the display effect. Specifically, a material of the light shielding layer 15 may be similar to that of a black matrix.

Optionally, the display device further includes a driving circuit 4 connected with the display panel 1, and the controller controls the driving circuit 4 to input a driving signal to the display panel 1 to drive the display panel 1 to display an image.

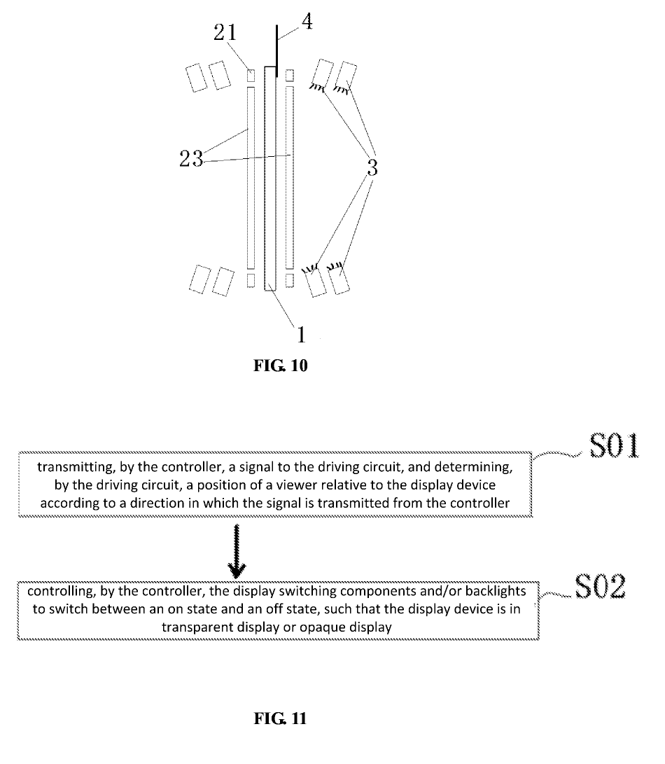

That is to say, as illustrated in FIG. 10, the driving circuit 4 is connected to one edge of the display panel 1, and configured to provide a digital signal (i.e., a driving signal) to the display device so as to drive the display panel 1 to display. Specifically, in a case where the display panel 1 is a liquid crystal display panel 1 and if the side of the color filter substrate 12 is the front side for the viewer, the digital signal needs to be inverted when the viewer views at the side of the array substrate 11.

Optionally, the controller includes a manual switch or a remote sensor.

That is to say, by using the manual switch or the remote sensor (namely, a remote controller) to control the display panel 1 to be on or off and turn on the light source at a corresponding side of the display panel 1, the driving circuit of the display panel 1 identifies a direction in which a signal is transmitted from the controller, determines a position of the viewer according to the identified direction (that is, determines which side of the display panel 1 is the viewer located at), and determines whether the digital signal for display needs to be inverted. When the viewer is at the front side (the side of the color filter substrate 12) of the display panel 1, the display signal is not inverted. When the viewer is at the back side (the side of the array substrate 11) of the display panel 1, the display signal is inverted to display accordingly.

The display panel of the display device according to the embodiments of the present disclosure includes two display surfaces, and the controller controls the display switching components and the backlights at both sides of the display panel to switch between an on state and an off state, such that the display device is in transparent display or opaque display. Specifically, when the display switching component at one side is controlled to turn on, the display device is in single-sided opaque display; when the backlight at one side is controlled to turn on and the display switching components at both sides are controlled to turn off, the display device is in single-sided transparent display. As such, the display device according to the embodiments of the present disclosure can meet various viewing requirements.

Embodiments of the present disclosure also provide a method for driving the aforementioned display device. The display device includes a display panel, display switching components, backlights and a control. The display panel includes two display surfaces. The display device may further include a driving circuit for driving the display panel to display. As illustrated in FIG. 11, the method includes the following steps.

At step S01, the controller transmits a signal to the driving circuit, and the driving circuit determines a position of a viewer relative to the display device according to a direction in which the signal is transmitted from the controller. That is, on account of two display surfaces included in the display panel, the controller determines which side of the display panel is the viewer located at, so as to determine the side on which the display switching component and/or backlight is to be turned on for display.

At step S02, the controller controls the display switching components and/or backlights to switch between an on state and an off state according to a result of the above determination, such that the display device is in transparent display or opaque display. The controller includes a manual switch or a remote sensor. Specifically, by using the manual switch or the remote sensor (namely, a remote controller) to control the display panel to be on or off and turn on the light source at a corresponding side of the display panel, the driving circuit of the display panel identifies which side of the display panel is the controller on, and determines whether the digital signal needs to be inverted.

It should be noted that many variations may be made to the specific implementations of the above embodiments. For example, the specific material of the light guide plate provided with the light scattering particles may be changed according to the actual product, and the way in which the retractable curtain is retracted and unfolded and the arrangement of the shaft may be adjusted as needed.

Embodiments of the present disclosure provide a display device, which may be any product or component having a display function, such as an electronic paper, a tablet computer, a television, a display or the like.

It can be understood that the foregoing implementations are merely exemplary implementations used for describing the principle of the present disclosure, but the present disclosure is not limited thereto. Those ordinary skilled in the art may make various variations and improvements without departing from the spirit and essence of the present disclosure, and these variations and improvements shall fall into the protection scope of the present disclosure.

1. A display device, comprising:
a transparent display panel comprising two display surfaces each capable of displaying an image;
display switching components provided at the two display surfaces of the display panel, respectively, and configured to switch a state of the display device between a transparent state and an opaque state; and
a controller configured to control the display switching components to turn on or turn off, such that the display device is in the transparent state when each of the display switching components is turned off and in the opaque state when one of the display switching components is turned on.

2. The display device of claim 1, wherein the display switching components are provided parallel to the display surfaces of the display panel.

3. The display device of claim 1, wherein each of the display switching components comprises a light guide plate provided with light scattering particles, and a first light source provided on at least one side of the light guide plate, the first light source being an edge-type light source, and
the controller is configured to control the first light sources to turn on or turn off, such that the display device is in the transparent state when each of the first light sources is turned off and in the opaque state when one of the first light sources is turned on.

4. The display device of claim 1, wherein each of the display switching components comprises a retractable curtain, and
the controller is configured to control the curtains to retract or unfold, such that the display device is in the transparent state when each of the curtains is retracted and in the opaque state when one of the curtains is unfolded.

5. The display device of claim 4, wherein each of the display switching components further comprises a second light source provided between the curtain and the display panel.

6. The display device of claim 4, wherein shafts are provided close to one side edge of the display panel, one end of each of the curtains is fixed onto one of the shafts, and each of the shafts is capable of rotating to retract or unfold the curtain.

7. The display device of claim 4, wherein each of the curtains is made of a flexible and reflective material.

8. The display device of claim 5, wherein in each of the display switching components, a light emitting direction of the second light source is a direction towards the curtain.

9. The display device of claim 1, wherein the controller is configured to control the display switching component at one of the display surfaces to turn on and the display switching component at the other of the display surfaces to turn off, such that the display device is in the opaque state.

10. The display device of claim 1, further comprising:
backlights provided at the two display surfaces of the display panel, respectively, and configured to provide backlight to the display panel,
wherein in a case where the display device is in the transparent state, the controller is configured to control the backlight at one of the two display surfaces to turn on, such that the display panel displays an image on one of the two display surfaces in a transparent state.

11. The display device of claim 1, wherein the display panel is a double-sided liquid crystal display panel comprising an array substrate, and a thin film transistor is disposed on a substrate of the array substrate.

12. The display device of claim 11, wherein the thin film transistor comprises a metal component, and a light shielding layer is provided between the metal component and the substrate.

13. The display device of claim 1, further comprising a driving circuit connected with the display panel, and the controller is configured to control the driving circuit to input a driving signal to the display panel to drive the display panel to display.

14. The display device of claim 13, wherein the driving circuit is configured to provide a normal driving signal when an image is displayed on one of the display surfaces and provide an inverted driving signal when the image is displayed on the other of the display surfaces opposite to the one display surface, the inverted driving signal being generated by inverting the normal driving signal.

15. The display device of claim 14, wherein the driving circuit is configured to identify a position of a viewer viewing the display device according to a signal from the controller, and provide one of the normal driving signal and the inverted driving signal according to the position of the viewer.

16. The display device of claim 13, wherein the controller comprises a manual switch or a remote sensor.

17. A method for driving a display device,
the display device comprising:
a transparent display panel comprising two display surfaces each capable of displaying an image;
display switching components provided at the two display surfaces of the display panel, respectively, and configured to switch a state of the display device between a transparent state and an opaque state;
a controller configured to control the display switching components to turn on or turn off, such that the display device is in the transparent state when each of the display switching components is turned off and in the opaque state when one of the display switching components is turned on; and
comprising a driving circuit for driving the display panel to display,
the method comprising:
transmitting, by the controller, a signal to the driving circuit, and determining, by the driving circuit, a position of a viewer viewing the display device relative to the display device according to a transmitting direction of the signal; and
controlling, by the controller, the display switching components to turn on or turn off according to the determined position of the viewer relative to the display device such that the display device is in the transparent state when each of the display switching components is turned off and in the opaque state when one of the display switching components is turned on.

18. The method of claim 17, wherein each of the display switching components comprises a light guide plate provided with light scattering particles, and a first light source provided on at least one side of the light guide plate, the first light source being an edge-type light source, and
the controlling step comprises:
controlling, by the controller, the first light sources to turn on or turn off, such that the display device is in the transparent state when each of the first light sources is turned off and in the opaque state when one of the first light sources is turned on.

19. The method of claim 17, wherein each of the display switching components comprises a retractable curtain, and
the controlling step comprises:
controlling, by the controller, the curtains to retract or unfold, such that the display device is in the transparent state when each of the curtains is retracted and in the opaque state when one of the curtains is unfolded.

20. The method of claim 17, wherein the display device further comprises backlights provided at the two display surfaces of the display panel, respectively, and configured to provide backlight to the display panel, and
the controlling step comprises:
in a case where the display device is in the transparent state, controlling, by the controller, the backlight at one of the two display surfaces to turn on, such that the display panel displays an image on one of the two display surfaces in a transparent state.
